(19) United States
(12) Patent Application Publication
(10) Pub. No.: US 2016/0129731 A1
(43) Pub. Date: May 12, 2016

(54) PNEUMATIC VEHICLE TIRE

(71) Applicant: Continental Reifen Deutschland GmbH, Hannover (DE)

(72) Inventors: Jakob John, Hannover (DE); Michal Lacko, Puchov (SK); Miguel Bispo, Hannover (DE); Bridget Owens, Hannover (DE)

(21) Appl. No.: 14/997,146

(22) Filed: Jan. 15, 2016

Related U.S. Application Data
(63) Continuation of application No. PCT/EP2014/057458, filed on Apr. 14, 2014.

(30) Foreign Application Priority Data
Jul. 15, 2013 (DE) 10 2013 107 476.6

(51) Int. Cl. B60C 9/20

(52) U.S. Cl. CPC B60C 9/20; B60C 2009/2093; B60C 2009/0071

(57) ABSTRACT

A pneumatic vehicle tire for commercial vehicles includes a belt having five belt plies having respective sets of reinforcements. The five plies are identified as first, second, third, fourth and fifth plies. The third ply is a 0° ply and the second and fourth belt are working belt plies. The sets of reinforcements of the first and second plies lying adjacent one side of the 0° ply run upward at respective positive slopes and the sets of reinforcements of the fourth and fifth plies lying adjacent the other side of the 0° ply run upward at respective negative slopes. The reinforcements of the fifth ply and the peripheral direction (A-A) of the tire conjointly define an angle φ between 35°≦φ≦70°. The reinforcements in the second and fourth plies having an elongation of ≧0.2% at 10% breaking load. The elongation is measured using reinforcements taken from a fully vulcanized tire.

### CROSS REFERENCE TO RELATED APPLICATIONS

This application is a continuation application of international patent application PCT/EP2014/057458, filed Apr. 14, 2014, designating the United States and claiming priority from German application 10 2013 107 476.6, filed Jul. 15, 2013, and the entire content of both applications is incorporated herein by reference.

### FIELD OF THE INVENTION

The invention relates to a pneumatic vehicle tire of radial configuration for commercial vehicles, in particular trucks, buses and truck trailers, having a five-ply belt, the belt plies of which contain reinforcements, which run parallel to each other in each belt ply, wherein the third belt ply is a 0° ply, the width of which is less than the width of the directly adjacent belt plies, which are working plies, wherein the reinforcements in one belt ply that is adjacent to the 0° ply slope upward to the right and the reinforcements in the other belt ply that is adjacent to the 0° ply slope upward to the left.

### BACKGROUND OF THE INVENTION

A pneumatic vehicle tire of this kind is known from DE 10 2010 000 181 A1, for example. The belt of this pneumatic vehicle tire has at least four plies, wherein each belt ply contains steel cords as reinforcements, the steel cords sloping in the same direction in the radially outermost belt ply and in the outermost belt ply but one, the belt ply adjacent to the latter. The angle which the steel cords in the radially outermost belt ply enclose with the equator of the tire is larger by 6° to 15° than the angle which the steel cords in the outermost belt ply but one enclose with the equator of the tire. This measure is intended to obtain a reduction in rolling resistance which is maintained and thus remains effective over the entire life of the tire.

U.S. Pat. No. 6,367,527 discloses a fatigue-resistant belt structure for tires that form twin tires for the drive axle of heavy goods vehicles. The belt has at least two working plies consisting of inextensible cords, which run crosswise relative to one another and form angles of 10° to 45° to the circumferential direction. Between the radial carcass and the radially inner working ply there is a belt ply consisting of inextensible steel cords, which enclose an angle of at least 60° with the circumferential direction. Arranged between the two working plies is an additional ply containing steel cords aligned substantially in the circumferential direction. Arranged on the working ply situated radially furthest out and on each side of the tire is a second, additional ply, likewise containing steel cords as reinforcements that are aligned substantially parallel to the circumferential direction.

In a typical belt structure for heavy goods vehicles, known as a triangular belt, four belt plies with steel cords as reinforcements are provided, wherein the steel cords in the first and in the second belt ply have slope directions that coincide and the angle which the steel cords in the first belt ply enclose with the circumferential direction is 45° to 70° and the angle which the steel cords in the second belt ply enclose with the circumferential direction is 15° to 26°. The steel cords in the third and in the fourth belt ply generally have an opposite slope direction, wherein the angles which the steel cords in these two belt plies enclose with the circumferential direction are equal and are 15° to 20°. It is known that the angling of the steel cords in the individual belt plies can affect the wear of the tread, but the known belt structures are in need of improvement as regards uniform wear.

### SUMMARY OF THE INVENTION

Thus, it is an object of the invention to embody a pneumatic vehicle tire of the type described above having five belt plies in the belt assembly in such a way that the tire has improved wear in operation, especially uniform wear over the width of its tread.

According to the invention, the above object is achieved by virtue of the fact that the angle which the reinforcements in the fifth belt ply enclose with the circumferential direction of the tire is 35° to 70°, and in that the reinforcements in the two working plies have an elongation of ≧0.2% at 10% of the breaking load, wherein the elongation is measured using reinforcements taken from the fully vulcanized tire.

Of particular significance to the invention is the combination of a central 0° ply in the belt assembly with the fifth belt ply, the reinforcements of which enclose a relatively large angle with the circumferential direction, and with extensible reinforcements in the two working plies, the second and the fourth belt ply. The 0° ply ensures very good circumferential stiffness and is advantageous for uniform wear of the tread in the shoulder regions. The fifth belt ply, the reinforcements of which run at a relatively large angle to the circumferential direction, increases the transverse stiffness in the lateral tread regions of the tire and thereby makes the wear in the central region of the tread, in particular, uniform. The working plies having extensible reinforcements have a balancing effect on the circumferential and transverse stiffness. The invention thus makes available a tire having uniform tread wear over its entire width.

According to a preferred embodiment of the invention, the third belt ply, the 0° ply, is constructed from a plurality of partial plies in the axial direction. By means of this measure, the circumferential stiffness in the individual partial plies can be selectively influenced, for example, by means of differential prestressing of the reinforcements, thereby providing additional support for the achievement of uniform wear of the tread.

In another embodiment according to the invention, the angle which the reinforcements in the fifth belt ply enclose with the circumferential direction is at least 43°. By means of this measure, the transverse stiffness in the lateral tread regions of the tire can be optimized and, as a result, wear in the central region of the tread can be influenced even more effectively.

The reinforcements in the second and the fourth belt ply, the working plies of the belt structure, each enclose an angle of 14° to 30° with the circumferential direction. This measure is advantageous for belt durability.

Another advantageous embodiment of the belt structure envisages that the reinforcements in the first belt ply enclose an angle of 35° to 70°, in particular at least 43°, with the circumferential direction. In this case, the reinforcements in the first belt ply can likewise have an elongation at 10% of the breaking load of ≧0.2%, wherein the elongation is measured using reinforcements taken from the fully vulcanized tire. It is therefore also possible to embody and arrange the reinforcements of the first belt ply in such a way that they help to influence the transverse stiffness in the lateral tread regions of the tire. For this reason, it is also advantageously possible to provide reinforcements in the fifth belt ply, the elongation of which at 10% of the breaking load is 0.2%, wherein the elongation of these reinforcements is likewise determined using reinforcements taken from the fully vulcanized tire.

### BRIEF DESCRIPTION OF THE DRAWINGS

The invention will now be described with reference to the drawings wherein:

FIG. 1 shows a partial cross section through a pneumatic vehicle tire in the belt and tread region, showing one variant embodiment of the invention; and,

FIG. 2 shows a plan view of segments of the belt plies from FIG. 1.

### DESCRIPTION OF THE PREFERRED EMBODIMENTS OF THE INVENTION

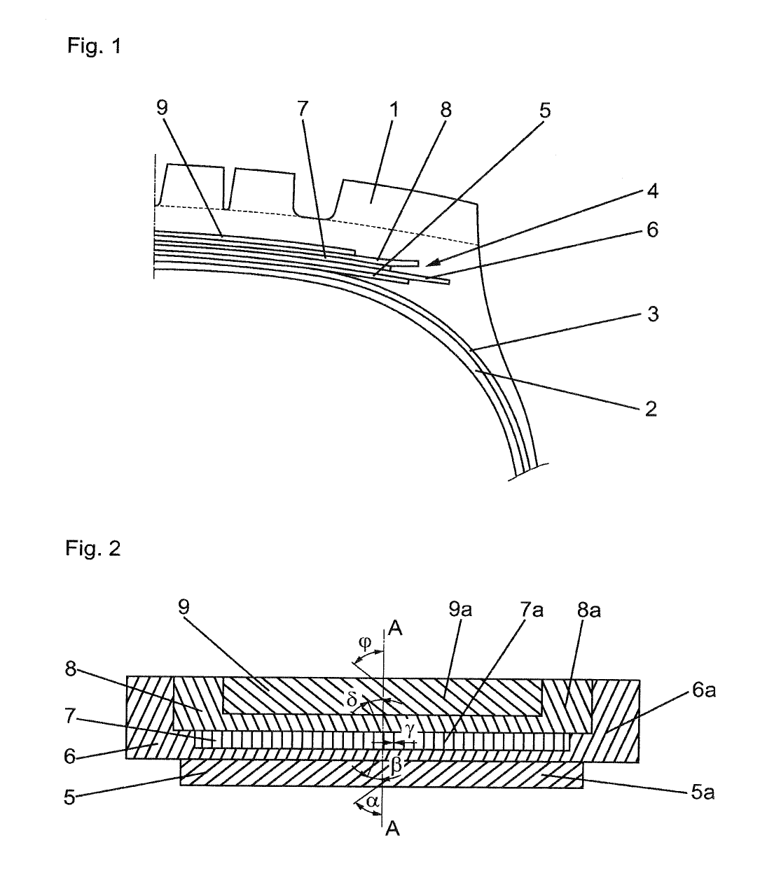

FIG. 1 shows a cross section through the tread and belt region of a pneumatic vehicle tire for commercial vehicles, for example, trucks, buses or truck trailers. Of the components that are generally present in the region of the pneumatic vehicle tire which is shown are a profiled tread 1, an inner liner 2, a carcass insert 3 and a multi-ply belt 4. The belt wedges and the like generally provided between the edge portions of the belt plies, in particular in the region of the belt ply edges, are not shown.

The belt 4 has five belt plies 5, 6, 7, 8 and 9, wherein the first belt ply is the radially innermost belt ply 5. The second and the fourth belt ply 6 and 8 are working plies, wherein the second belt ply 6 is wider than the fourth. Adjoining the fourth belt ply 8, which is therefore the narrower working ply, is the radially outermost belt ply 9, which has a width of at least 60% and at most 140% of the width of the third belt ply 7. All the belt plies 5, 6, 7, 8 and 9 consist of reinforcements 5a, 6a, 7a, 8a and 9a, which are embedded in a rubber mixture, the “belt rubber”, and which run parallel to one another in each ply, and steel cords or cords based on polyamides (aramid), polyesters, glass fibers or some other suitable material and embodied in a manner known per se, for example. The reinforcements could also be hybrid cords, in which filaments or yarns of different materials are processed to give a cord.

As FIG. 2 shows, the reinforcements 5a, 6a, 7a, 8a and 9a run at angles α, β, γ, δ and φ to the circumferential direction symbolized by the line A-A in the belt plies 5, 6, 7, 8 and 9. In the embodiment shown in FIG. 2, the slope of the reinforcements 5a, 6a, 7a, 8a and 9a relative to the circumferential direction A-A in the individual belt plies 5, 6, 7, 8 and 9 is such that, starting from the radially innermost belt ply 5, the reinforcements 5a, 6a, 7a, 8a and 9a slope upward in the following sequence: to the right—to the right—0°—to the left—to the left. A 0° belt ply should be taken to mean one in which the reinforcements run at an angle γ to the circumferential direction A-A which deviates from precisely the 0° orientation by at most ±5°. The angle α of reinforcements 5a in the first belt ply 5 is 35° to 70°, in particular 43° to 57°, the angle β of reinforcements 6a in the second belt ply 6 is 14° to 30°, the angle δ of reinforcements 8a in the fourth belt ply 8 is 14° to 30° and the angle φ of reinforcements 9a in belt ply 9 is 35° to 70°, in particular 43° to 57°. As already mentioned, the second belt ply 6 and the fourth belt ply 8 are working plies, and the reinforcements thereof therefore run at a relatively small angle to the circumferential direction.

It is essential for a belt structure according to the invention that the central belt ply 7 is a 0° ply and that the two belt plies (5, 6) and (8, 9) arranged radially to the inside and radially to the outside of the 0° ply, respectively, each have corresponding slopes. In an alternative embodiment of the invention, the 0° ply 7 can be constructed in the axial direction from a plurality of partial plies, which, in particular, are each formed by spirally wound reinforcements.

In another alternative variant embodiment, which is not shown especially, the belt plies are embodied in such a way that the reinforcements thereof slope in such a way relative to the circumferential direction A-A, starting from the first, the radially innermost belt ply, that they slope upward to the left in the two radially innermost belt plies and upward to the right in the two radially outermost belt plies. In other respects, this embodiment which is not shown corresponds to the embodiment described and shown in FIG. 1 and FIG. 2, in particular as regards the sizes of the angles α, β, γ, δ and φ mentioned.

The reinforcements in the two working plies 6 and 8, preferably also those in belt plies 5 and 9, are extensible, wherein “extensible” should be taken to mean that the reinforcements in the fully vulcanized tire have an elongation of ≧0.2% at 10% of the breaking load. The elongation is therefore measured on reinforcements taken from the fully vulcanized tire, wherein determination of the elongation takes place in accordance with ASTM D 2969-04.

The 0° ply in belt structures according to the invention brings about a very good circumferential stiffness of the tire in the tread region, this being advantageous for uniform wear of the tread in the shoulder regions. The radially outermost belt ply 9 having reinforcements which run at an angle φ of up to 70° to the circumferential direction A-A ensures good transverse stiffness, assists to provide uniform wear of the tread in the central region and, overall, lower tread wear.

It is understood that the foregoing description is that of the preferred embodiments of the invention and that various changes and modifications may be made thereto without departing from the spirit and scope of the invention as defined in the appended claims.

### LIST OF REFERENCE NUMERALS

1 tread
2 inner liner
3 carcass insert
4 belt
5, 6, 7, 8, 9 belt ply
5a, 6a, 7a, 8a, 9a reinforcement
A-A circumferential direction
α, β, γ, δ, φ angle

What is claimed is:

1. A pneumatic vehicle tire of radial configuration for commercial vehicles, the pneumatic vehicle tire comprising:
a belt having five belt plies having respective sets of reinforcements with the reinforcements of each set being arranged so as to be parallel to each other;
said five belt plies being disposed one atop the other and being successively identified as first, second, third, fourth and fifth belt plies;
said third belt ply being a 0° ply having a predetermined width and said second and fourth belt plies being working belt plies each directly adjacent said third ply;
said second and fourth belt plies having respective widths and said predetermined width of said third belt ply being less than each of said widths of said second and fourth belt plies;
the respective sets of reinforcements of said first and second belt plies lying adjacent one side of said 0° ply running upward at respective positive slopes and the respective sets of reinforcements of said fourth and fifth belt plies lying adjacent the other side of said 0° ply running upward at respective negative slopes;
said tire defining a peripheral direction (A-A);
said set of reinforcements of said fifth belt ply and said peripheral direction (A-A) conjointly defining an angle φ lying in a range of 35°≦φ≦70°;
the reinforcements of said sets of reinforcements in said second and fourth belt plies having an elongation of ≧0.2% at 10% breaking load; and,
said elongation being measured using reinforcements taken from a fully vulcanized tire.

2. The pneumatic vehicle tire of claim 1, wherein said third belt ply comprises several component plies in axial direction.

3. The pneumatic vehicle tire of claim 1, wherein said angle φ is at least 43°.

4. The pneumatic vehicle tire of claim 1, wherein the respective sets of reinforcements in said second and fourth belt plies and said peripheral direction (A-A) conjointly define respective angles (β, δ) which lie in a range of 14° to 30°.

5. The pneumatic vehicle tire of claim 1, wherein the reinforcements of the set of reinforcements in said first belt ply and said peripheral direction (A-A) conjointly define an angle α lying in a range of 35° to 70°.

6. The pneumatic vehicle tire of claim 5, wherein said angle α is at least 43°.

7. The pneumatic vehicle tire of claim 1, wherein the reinforcements of the reinforcement sets of said fourth and fifth belt plies run upward to the right.

8. The pneumatic vehicle tire of claim 1, wherein the reinforcements of the reinforcement set of said first belt ply have an elongation of ≧0.2% at a 10% breaking load; and, said elongation of said reinforcements of said first belt ply is measured using reinforcements from the fully vulcanized tire.

9. The pneumatic vehicle tire of claim 1, wherein the reinforcements of the reinforcement set of said fifth belt ply have an elongation of ≦0.2% at a breaking load of 10%; and, the elongation is measured using reinforcements from a fully vulcanized tire.

10. The pneumatic vehicle tire of claim 1, wherein said fifth belt ply has a width of at least 60% and at most 140% of said predetermined width of said third belt ply.

11. The pneumatic vehicle tire of claim 1, wherein said commercial vehicles include trucks, busses, and truck trailers.
